(19) United States
(12) Patent Application Publication
(10) Pub. No.: US 2012/0059687 A1
(43) Pub. Date: Mar. 8, 2012

(54) ORGANISATIONAL TOOL

(76) Inventors: Allen Ross Keyte, Auckland (NZ); Craig James Catley, Wellington (NZ); Simon Andrew Lawrence, Middlesex (GB)

(21) Appl. No.: 13/257,286

(22) PCT Filed: Mar. 18, 2010
(86) PCT No.: PCT/NZ10/00045

§ 371 Date: Nov. 23, 2011

(30) Foreign Application Priority Data
Mar. 18, 2009 (NZ) 575639
Jun. 30, 2009 (NZ) 578104

(51) Int. Cl. G06Q 10/06

(52) U.S. Cl. 705/7.37

(57) ABSTRACT

The invention provides systems, methods and apparatus for of determining and/or monitoring the strategic health of an organisation. The method includes receiving information, collating the information to form information artefacts, each information artefact having an impact on one or more aspects of the strategic health of an organisation, deriving a value for one or more of said information artefacts, and assessing a magnitude of the impact on the strategic health of the organisation based on the derived values.

### FIELD OF THE INVENTION

The invention relates to systems, methods and apparatus for structuring and/or storing and/or disseminating information, and preferably enables updating and/or restructuring of that information. More particularly, the invention relates to a tool for collating and structuring information relating to an entity, such as a commercial concern, to ensure particular subsets of the information are made available to respective individuals associated with the entity, preferably, in a predetermined manner. At least certain ones of the individuals may be able to update at least a portion of the information. The invention also provides for assessment of the financial impact of an initiative, again, with this preferably capable of being performed at various micro-/macroscopic levels.

### BACKGROUND OF THE INVENTION

Various strategic management tools are known in the art, an example of which is described in WO 97/31320. This document describes a strategic management system which integrates organisational plans and performance measures. The system includes organisation planning means for entering, aligning and linking a number of different organisational plans; indicator determination means for determining a series of indicators for the organisational plan; and benchmarking means for benchmarking the indicators against internal or external measurements or targets, wherein each of the means are interlinked into a single co-ordinated system. The computer-based framework provides an integrated approach to organisational planning, measurement of performance and undertaking of benchmarking of performance with other business units or organisations. All levels of an organisation may be interlinked and use a consistent planning structure based on shared information.

According to WO 97/31320, measures throughout a plan hierarchy may be related to a common set of key result areas. Business objectives and their actions, where defined, may be linked to a common set of strategic objectives, and each objective may in turn be linked to a set of strategic objectives. This assists in developing a consistent approach to achieving the overall aims of an organisation and in promoting a strategic management approach within the organisation. Performance data is preferably captured to enable a manager to upgrade and amend plans and other documents so that they remain current. Hence, organisational planning can be undertaken based on current data and the plans developed based on prospective views of an organisation, providing for continuous planning as part of strategic management behaviour. Responsibility, authority and accountability lines are identified for specific actions.

The system is capable of either enforcing or optionally sharing information in any form of operational structure. It is omni-directional and able to share and transfer information between plans.

While providing some functionality, conventional arrangements have a number of drawbacks or associated problems. These include, but are not limited to, limitations resulting from the data structure used (either in terms of limited functionality provided thereby and/or poor or limited ability to link between different data elements or groups of data elements), inadequate functionality for searching for specific data elements or types of data elements, limited or no real functionality for assessing the impact of particular events on an entity's overall strategy and inadequate overall assessment of an entity's strategic health.

### SUMMARY OF THE INVENTION

It is an object of the invention to provide a system and/or method and/or apparatus which at least ameliorates one or more of the aforementioned problems.

Alternatively, it is an object of the invention to at least provide a useful choice to the public.

According to a first aspect of the invention, there is provided an organisational tool, including:

means for receiving information;

means for collating the information to form information artefacts, each information artefact having an impact on one or more aspects of the strategic health of an organisation;

means for deriving a value for each said information artefact; and

means for assessing a magnitude of the impact on the strategic health of the organisation based on the derived values.

Preferably, the information includes a subset of the organisation's entire proprietary information, and the organisational tool includes means for extracting data relevant to the organisation's strategic health so as to form the subset of information, wherein the information received by the means for receiving includes the subset of information.

Preferably, the means for assessing is configured to assess the magnitude of the impact based on a function of each said information artefact.

According to one embodiment, the means for assessing includes weighting means for applying a weighting coefficient to one or more of the information artefacts. Additionally or alternatively, the means for assessing includes sensitivity means for applying a sensitivity analysis to one or more of the information artefacts. Sensitivity analysis may include apportionment of model uncertainty when considering given inputs against given outputs. Application may be numerical or otherwise. For example, utilising ranges or patterns such as low/medium/high effect.

Preferably, the tool includes input means for inputting information relating to the organisation.

Preferably, the tool includes display means for displaying at least a portion of one or more of the information artefacts and/or the derived values therefor and/or the magnitude of the impact on the organisation's strategic health.

Preferably, the tool includes means for transmitting at least a portion of one or more of the information artefacts and/or the derived values therefor and/or the magnitude of the impact on the organisation's strategic health.

According to preferred embodiments, the organisational tool is embodied in software and/or hardware.

According to a second aspect, there is provided an information and/or computing system including:

the organisational tool of the first aspect;

a user terminal; and

a wired and/or wireless communications interface for exchanging data between the organisational tool and the user terminal.

As will be appreciated, the tool may be incorporated within the user terminal, in whole or in part, and vice versa.

Preferably, the user terminal includes data input means.

Preferably, the user terminal includes display means.

Preferably, the system includes a plurality of said user terminals, wherein the communications interface is configured to exchange data between the organisational tool and each user terminal.

Preferably, the system includes user access means for restricting access to the system to authorised users. Any known means may be used, such as assigned usernames and passwords. Furthermore, the user access means may be adapted to assign different access privileges to different users so that the extent of access to read or view information in the system may be varied and/or the extent a user can write or input data to the system.

According to a third aspect, there is provided a method of determining and/or monitoring the strategic health of an organisation, the method including:

receiving information;

collating the information to form information artefacts, each information artefact having an impact on one or more aspects of the strategic health of an organisation;

deriving a value for each said information artefact; and

assessing a magnitude of the impact on the strategic health of the organisation based on the derived values.

Preferably, the information includes a subset of the organisation's proprietary information, and the method includes extracting data relevant to the organisation's strategic health so as to form the subset of information, wherein said receiving includes receiving the subset of information.

Preferably, the step of assessing includes assessing the magnitude of the impact based on a function of each said information artefact.

Preferably, the step of assessing includes applying a weighting and/or sensitivity coefficient to one or more of the information artefacts.

Preferably, the method includes inputting information relating to the organisation.

Preferably, the method includes displaying at least a portion of one or more of the information artefacts and/or the derived values therefor and/or the magnitude of the impact on the organisation's strategic health.

Preferably, the method includes transmitting at least a portion of one or more of the information artefacts and/or the derived values therefor and/or the magnitude of the impact on the organisation's strategic health.

According to preferred embodiments, the method is computer-implemented.

According to a fourth aspect, there is provided computer readable instructions which when executed by a suitably enabled computing device perform the method of the third aspect.

Thus, the invention provides a computer-implemented method for calculating and communicating the health of an organisational strategy or group of strategies based on a plurality of strategic health variables and rules for using and/or manipulating the variables, the method including augmenting the strategic health calculation using weighting and/or sensitivity coefficients for one or more of the variables.

Each of the variables is primarily set via the existence of information artefacts that are inferred to support a particular organisational strategy or group of strategies. Preferably, the information artefacts are identified through a single or series of search passes which determine linkage between data elements constituting an information artefact.

According to one embodiment, linkages between one or more data elements may be assigned by a user.

The strategic health calculation may be augmented by including additional variables or rules in the strategic health calculation.

Additionally or alternatively, the strategic health calculation may be augmented by nullifying one or more of the variables or rules used in the strategic health calculation.

One or more factors of the strategic health calculation may be specified by a user.

According to one embodiment, the strategic health calculation is hard-coded.

According to particular embodiments, the strategic health calculation includes one or more conditional operators that are evaluated during the calculation.

Preferably, means are provided to enable a user to modify one or more aspects of the strategic health calculation. The modifying may include one or more of adding, deleting or changing one or more of the strategic health variables and/or rules.

Additionally or alternatively, the strategic health calculation is adaptive such that one determination of the strategic health calculation may modify the determination made by a subsequent strategic health calculation.

Preferably, means are provided for assigning user ownership of an organisational strategy or group of strategies.

Preferably, means are provided for assigning a hierarchy of strategies and/or a hierarchy of users.

Preferably, the assignment of strategies to users is based at least in part on the hierarchy.

Additionally or alternatively, the user input means is configurable to enable a user to assign a strategy or to modify the assignment of a previously assigned strategy.

The step of modifying an assignment may include one or more of adding, deleting or changing one or more ownership assignments to determine a subsequent assignment.

According to further aspects, there are provided a system/method/apparatus for establishing a value to apportion to a corporate strategy or aspects thereof, so as to provide an indication of expected returns of the efforts of individuals, groups of individuals and/or the entire entity.

Preferably the value is a financial measure.

These further aspects may be implemented using the invention according to any one of the first four aspects, configured to establish the value only, or to assess the value in combination with other assessments referred to in relation to the first four aspects. Thus, for example, the magnitude of the impact assessed in the first aspect may be a financial measure (such as a measure of likely income and/or resultant cash flow).

Preferably, financial measures are determined to capture, for example, the cash flows that a child or parent initiative will incur and generate. For example, 10 annual periods plus residual ongoing may be assessed. The value added by an initiative can therefore be calculated (such as the net present value NPV), using a global or individually set hurdle rate.

Preferably, when an initiative is created at a given point within a trunk of strategy, business case cash flows may be captured that embody the expected or actual value.

Preferably, continual tracking of initiative performance is allowed by capturing the latest value estimates from the initiative owner and/or reviewer.

Additionally, value may be consolidated across either all or part of a trunk of a strategic framework; thus providing an aggregated view of value created at higher levels.

Preferably, initiative owners or reviewers are provided with means to consolidate cash flows bottom up from child levels under parent levels, including the ability to assign these capabilities to other users for input.

Values which are aggregated at the parent level, may also have additional cash flows added at a later point in time.

Thus, strategy value planning and progress tracking through to completion of a complete overall strategic value of efforts and/or components thereof is enabled. As would be apparent, during the life of an initiative, estimated costs and returns impacting the financial measures may be replaced or adjusted by actual costs and returns, as desired.

Initiatives may also have final estimates or actuals on cash flows and benefits entered to determine the relative success or failure when compared to an earlier estimate.

Preferably, the invention further provides the ability to import and export subsets or portions of the strategic plan and the associated value equations for future reuse, thus enabling cash flows to be added or removed from a current aggregated view.

Initiative owners and reviewers may also rate the success of an exported or imported section of the strategic plan. In this way initiatives may be filtered, sorted and/or compared to see those that were considered successful and those that were not from a given viewpoint.

An additional benefit or advantage that may be realised by embodiments of the invention include the expected increase or decrease in organisational ownership value over that at a given point in time.

Preferably, means are provided for inputting or connecting an organisation's ownership value (for example, the current market capitalisation and/or share price) and aggregating this with a given consolidation of expected or actual value from defined initiatives.

According to preferred embodiments, the invention provides for calculation and display of value augmentation over/under the current ownership levels and may be used to help establish the significance and differentiation of diverse or similar objectives.

Thus, the invention preferably provides means for calculating and communicating the expected value of an organisation in terms of its proposed strategic goals. Moreover, the invention provides for this assessment at varying levels with the possibility of assessing returns of an initiative essentially in isolation from other initiatives, in combination with at least one other initiative, at a global level, or any level in between, with account being taken of the impact of one initiative on another (for example, while a new initiative may provide for a high return in isolation, it may draw resources from other initiatives at the expense thereof, ultimately resulting in a loss). This is preferably enabled through use of the data structure of the invention whereby different information artefacts are linked, such that a change in a measure in relation to one initiative may provide for a measurable impact on another initiative.

Further aspects of the invention, which should be considered in all its novel aspects, will become apparent to those skilled in the art upon reading the following description which provides at least one example of a practical application of the invention.

### BRIEF DESCRIPTION OF THE DRAWINGS

One or more embodiments of the invention will be described below by way of example only and without intending to be limiting with reference to the following drawings, in which:

FIG. 1 is a schematic tree diagram of a corporate strategy;

FIG. 2A shows an example set of variables and rules that may be used in the method of the invention;

FIG. 2B shows an alternative example to that of FIG. 2A;

FIG. 3 is a schematic diagram of a system according to an embodiment of the invention;

FIG. 4 is a flow illustrating method steps according to one embodiment; and

FIG. 5 is an example screenshot according to an embodiment of the invention.

### DETAILED DESCRIPTION OF THE PREFERRED EMBODIMENT

In broad terms, the invention provides for the communication of corporate strategy efficiently across all personnel of an entity or enterprise, thereby aligning the efforts of individuals, groups of individuals and ultimately the entire entity with that strategy.

Embodiments of the invention are preferably embodied in software, which when executed on a suitably enabled computing device, performs the method of the invention. As would be apparent to those skilled in the art, the processing may be carried out and displayed by a single device but, preferably, at least data entry and display is enabled at other computing devices using any known communication means, such as but not limited to the internet. Furthermore, distributed processing may be used as would also be apparent to those skilled in the art.

The invention may conveniently make use of technologies emerging as part of what has become “Web 2.0” (e.g. blogging, tagging, RSS—Really Simple Syndication), preferably through web-based software in the form of a SaaS (Software as a Service) delivery model, although embodiments may additionally or alternatively be provided, for example, on a preinstalled dedicated server appliance, preferably with the capability to interface to internal corporate information such as search indexes and to organise information (either structured or unstructured) around strategies.

The invention provides a tailorable framework for creating and managing strategic initiatives, with a virtually unlimited number of custom levels and dimensions, as will become more apparent from the description hereinbelow. Progress towards achievement of strategy is percolated up from the lowest level task(s), such that progress of each child is rolled up to or considered for the status of its parent, parents are rolled up to the next level, and so on.

The invention provides a unique visual interface which preferably uses coding techniques to achieve fluid navigation. Graphically representing strategy is by no means a straightforward task. According to embodiments of the invention, a method is used which allows display in a tree-like structure from the highest level to the lowest (or vice versa) within the context of the siblings of a main trunk, providing the ability to view top to bottom and/or bottom to top in a strategic context.

The invention further provides the ability to integrate employees with specific ownership and accountability at any level of the strategy. This is achieved through self, peer or management level review/control of tasks and activities, providing ownership at a child or parent level. When levels are completed, owners of parent levels can validate completion. During progress, the system may be configured to escalate and notify (such as through email integration) when tasks at any level of strategy fall behind expected or scheduled progress (by date or otherwise) and automatic escalations may occur. Such escalations may be set according to any desired criteria. For example, those notified may depend on the extent a task or group of tasks falls behind a scheduled completion date.

The invention preferably further provides the ability to import and export subsets or portions of a strategic plan for future reuse. Using a tree-type structure, at any node, all children thereof are archived, providing for ready portability whereby such information may be imported to any other position in the structure, or to a different structure.

The invention preferably further provides the ability to prioritise strategies, initiatives, projects and tasks etc.

Multithreaded strategic discussions (Blogging/Chatting) are preferably enabled. More preferably, at selected nodes or any node within the structure, a user may start a multithreaded conversation with any other user. Access to such conversations may be restricted such that only relevant persons are included within each particular forum. The thread, or a link thereto, is preferably displayed adjacent to the actual block/node it relates to.

The invention enables strategy lifespan planning and progress tracking through to completion of a complete overall strategy and/or components thereof. Strategic initiatives may be scheduled to commence and be completed at any points in the future.

In addition to the aforementioned escalation notices, notification messages may be generated as and when desired. For example, a project leader may wish to receive a weekly progress report for all nodes for which they are responsible. Additionally or alternatively, they may request to be notified at given increments in the progress of a project (e.g. in 10% blocks up to completion of a project or each time a predetermined milestone is met). Email, such as Microsoft Exchange, provides a convenient means for conveying such notifications and progress updates, although the invention is not limited thereto. The invention preferably further provides for integration with conventional project management software such as Microsoft Project. This may be achieved by uploading projects via XML into nodes. Other formats may alternatively be used.

The invention further provides user and enterprise level (and levels therebetween) analytics as well as graphical views of components of and the entire overall strategy of an entity.

The key role of the invention is to effectively communicate the health of an entity's strategies and how they are supported (or not), using actual data residing within, derived or inputted from the entity.

While the front-end implementation of the invention is preferably a SaaS model, the search index for any given entity will tend to be closely held within that entity's IT environment since each search index is proprietary—no standards currently exist. This raises a number of major complexities, namely how to identify and locate particular information artefacts or data elements relating to a particular entity's strategy.

In order to provide a useful tool, embodiments of the invention need to be able to report the existence and location of information artefacts (structured and/or unstructured) through to the front-end in real-time. If a report is deleted or updated from the index, this needs to be reflected near real-time for the system to be accurate and strategically relevant.

Multiple search indexes exist such as Google Search Appliances, IBM Cognos Go! Search, Autonomy, Microsoft Enterprise Search, IBM OmniFind etc. The invention provides connectivity to such indexes, and also for the interpretation and dissemination of the results though to the front-end, all in or near to real-time, however it may include batching processes (for given situational performance). Crucial to this is identifying what information is relevant to strategy and only replicating or making use of that information, particularly in view of the amount of information entity's typically hold. Embodiments of the invention may conveniently provide for the display of such information, including providing access to particular related files (e.g. reports, emails, documents etc) such as through appropriate links thereto. As will be apparent to those skilled in the art, this requires significant application integration which has not been achieved or satisfactorily achieved by prior art approaches.

Solutions to the problem of how to locate information artefacts in the form of an application installed at an entity's premises pose complex challenges. Further challenges are imposed in the generation of a solution based on a SaaS model since there is an even greater concern over the integrity or security of the information, which is important in view of the type of information being processed.

Particular embodiments of the invention address these problems by providing an “ultra light weight” search index agent program that is contained within the entity's environment (i.e., their local network or a portion thereof) and has the capability to encrypt and rapidly pass data to the front-end. Due to the peculiarities of the information associated with each entity and the means provided for identifying and locating such information, the search index agents or “bots” may be tailored, at least to some degree, to each individual entity search engine. Work processes, notifications, documents, reports, emails etc in different entity applications may be examples of artefacts identified by the search index agents.

Following extraction and collation of information by the search index agents, a strategy based inference engine is used to process the information artefacts, each of which may vary in relevance to the entity's strategy. This engine uses models and statistical approaches and mathematical engines to correlate and/or derive the value that the aggregated artefacts or data elements provide for strategy support.

While some techniques have been developed which provide functionality for a small subset of specific information artefacts, it is preferable that the invention is capable of considering all aspects of information which may be relevant to an entity's strategy.

Following processing by the strategy based inference engine to place a value on the information artefacts found by the search agent, a relevance engine is used to assess the impact of an individual's activities, and to indicate to that individual and any other relevant individuals, what, if any, subsequent tasks they should be performing. The relevance engine preferably apportions some value or score to each task, so as to generate lists of tasks to be performed according to priority. The priorities for each task may be predetermined or determined using a rules engine. According to preferred embodiments, individuals within an organisation may view the tasks that have been assigned to them. Depending on authorisation rights which may be set by a system administrator, individuals may or may not be able to view information associated with other individuals. For example, one individual may only be able to view the particular tasks assigned to them. The team leader of that individual may be able to view their team's overall tasks or goals as well as the goals/tasks of each individual within the team, and so on. While some control or restriction over information flow is generally desired within an organisation, preferably, embodiments of the invention enable an individual at any particular layer within an entity to view at least a portion of the information in the layers above them so that the broader strategy of the entity is apparent to them, as well as the impact they may have on that strategy.

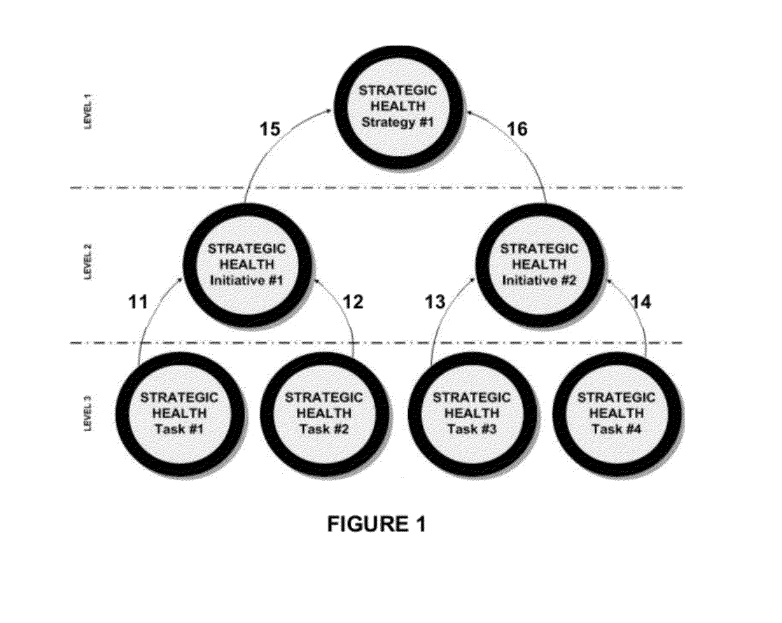

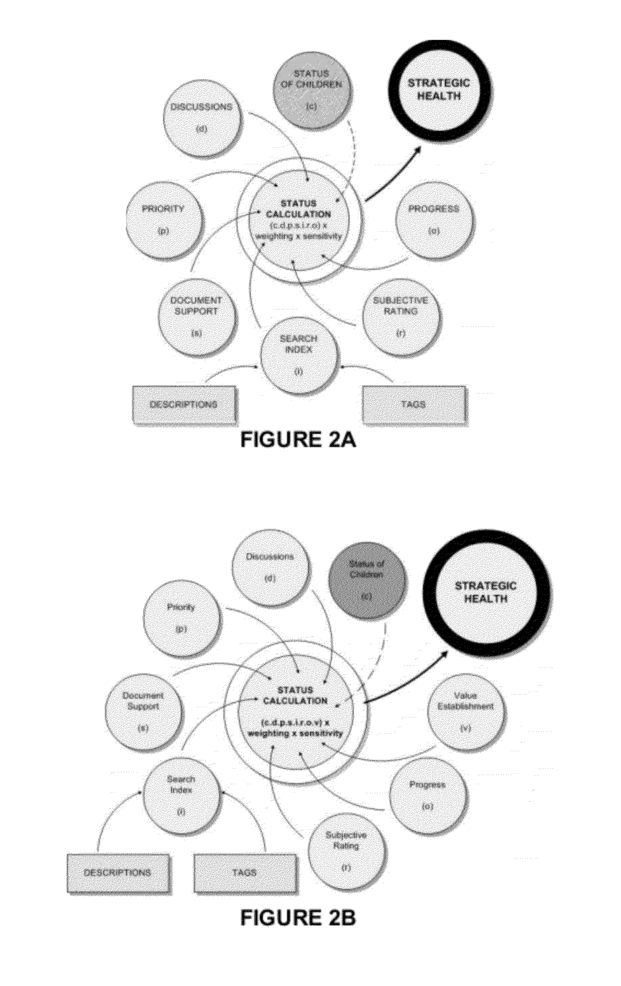

The operation of the strategy based inference engine and the relevance engine will be better understood from the description below with reference to FIGS. 1 and 2.

FIG. 1 shows an example breakdown of an entity's corporate strategy. The overall entity's objectives are set out in level one and labelled in FIG. 1 as “STRATEGIC HEALTH Strategy #1”. As would be apparent, additional such strategies may be added but to ensure clarity, only one is shown. Also, the term “entity”, “enterprise” or the like as used herein is to be given a broad interpretation and may include, as desired, affiliates or associates of that entity, particularly where such affiliates may impact on the strategy.

Additional levels are shown in FIG. 1. Level two is provided for “STRATEGIC HEALTH Initiatives” and Level three for “STRATEGIC HEALTH Tasks”. The initiatives may be projects and the tasks may be particular action items required on a project. As would be apparent to those skilled in the art, additional layers may be added as required. Also, a greater or fewer number of items may be included at each level within the structure.

Within the structure of FIG. 1, various links 11 to 16 exist. STRATEGIC HEALTH Initiative #1 may be considered as the parent of STRATEGIC HEALTH Task #1 as Task #1 contributes to or effects Initiative #1 as indicated by link 11. Similarly, STRATEGIC HEALTH Initiative #1 may be considered as a child of STRATEGIC HEALTH Strategy #1 as Initiative #1 contributes to or effects Strategy #1 as indicated by link 15. The other items and links within FIG. 1 may be referred to in a similar way. Note, while not shown, a child may have more than one parent. For example, STRATEGIC HEALTH Task #3 could have an additional link to Initiative #1 if Task #3 also had an impact on that initiative. Thus, the particular structure used will depend on the particular goals and desired breakdown thereof for the entity in question.

FIGS. 2A and 2B show example sets of variables and rules that may be used in the method of the invention. Further details of each of these variables/rules are provided below.
(c) Status of Children—this variable may be calculated from the combined average value of the strategic health calculations of all the children items directly beneath any particular item within the structure of an organisation's strategy (see FIG. 1). This variable is not used for items at the bottom level of the structure as these items by definition have no children.
(d) Discussions—preferably provided in the form of micro-blogging, this enables end users of the system to join in and contribute to multi-threaded strategic discussions focused on an individual activity (or any group of activities) contained within any of the levels of the organisation's strategy. This provides a forum which may be viewed in context with the actual item/activity it is associated to. A numeric value may be derived by the volume of discussions and how current or how recently contributions have been made.
(p) Priority—within each level items within the overall strategy may be ranked by priority and given a numeric value. These items may be reordered at any time so the determination may be constantly regenerated or updated.
(s) Document Support—End-users of the system may be provided with the ability to upload files to support the specific strategic items they are accountable for. A numeric value may be derived, driven by the volume of files and how current or recently these supporting documents have been added. Subsequent download or retrieval of such files may be provided for
(i) Search Index—textual information relating to an item is gathered by the system through the use of item titles, descriptions and keyword “tags” that are used to describe it. These terms may be run against internal search indexes (following indexing of the organisation's internal files) to measure the existence of information artefacts that are structured (e.g. reports, spreadsheets) or unstructured (e.g. email, documents). If an artefact is deleted or updated, from the index this is preferably reflected near real-time so that the system is kept accurate and strategically relevant. A numeric value may be derived based on the quality and relevance of the search results. Such derivation may be provided in the form of a strategy based inference engine that statistically models the applicability or relevance or quality of an information artefact or set of artefacts to an item or set of items.
(r) Subjective Rating—the system may prompt the end user periodically to enter a numeric value to show at that point in time their level of confidence in the specific task or activity they are accountable for.
(o) Progress—each item at every level of the strategic structure may have a start and finish date. At certain points in time end-users may be prompted to enter a numeric value to describe achievement towards completion.
(v) Value Establishment—a value may be apportioned to a corporate strategy and/or an aspect thereof. The value may be indicative of expected returns of the efforts of individuals/groups/an entire entity. The expected returns may be updated, at least based in part, on actual returns.

Additionally, weightings or sensitivity coefficients may be used, at least for particular ones of the variables. More particularly, through Weightings, the system may allow for each of the above variables to be configured as desired by each individual organisation, whereby each organisation is able to tailor the invention to reflect their own perceived importance of certain variables used in assessing or calculating strategic health. The “Sensitivity” may be applied numerically or otherwise, for example utilising ranges or patterns such as low/medium/high effect; whereby the sensitivity analysis may include apportionment of model uncertainty when considering given inputs against given outputs.

Preferably, a numeric value is assigned to or calculated for an entity's strategic health. This value is a function of the above variables as well as any weightings and sensitivities. As shown in FIG. 2A, this function may be represented as:

STRATEGIC HEALTH=(c.d.p.s.i.r.o)×weighting×sensitivity

Alternatively, as shown in FIG. 2B, it may be represented as:

STRATEGIC HEALTH=(c.d.p.s.i.r.o.v)×weighting×sensitivity

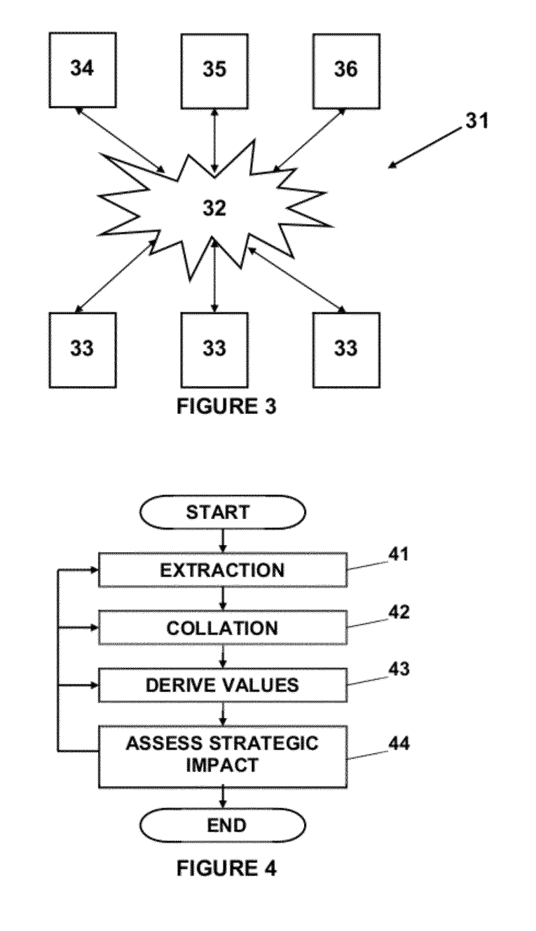

FIG. 3 shows a schematic representation of an example system 1 which may be used to implement the invention. Note that the particular arrangement used may be varied as required as would be apparent to those skilled in the art, and the invention is not limited to the particular arrangement shown.

Referring to FIG. 3, elements or stations within system 31 exchange information via communication medium 32. Any known wired or wireless communications means may be used with individual communications being directly or indirectly forwarded to an intended recipient station. Communication medium 32 may conveniently include the internet.

User terminals 33 may be used to input or output data items and/or view data items, as well as to communicate with other user terminals, preferably within a particular entity.

Also included within system 31 is search index agent module 34, strategy based inference engine 35 and relevance engine 36, which have the functions described hereinabove. As would be apparent to those skilled in the art, modules 34, 35, 36 may be formed integrally as a single unit.

FIG. 4 is a flow diagram of an example method according to the invention. The method begins at step 41 with the extraction of data from an entity's information systems by search index agent module 34. This information is collated at step 42 and values derived for individual or aggregated information artefacts by strategy based inference engine 35 at step 43. These values are used by relevance engine 36 to assess the impact of events on the entity's strategy at step 44. Each step is preferably performed on a continuous basis as shown by the feedback lines. This is to ensure that the assessment is updated in or approaching real-time even though particular information artefacts may vary considerably.

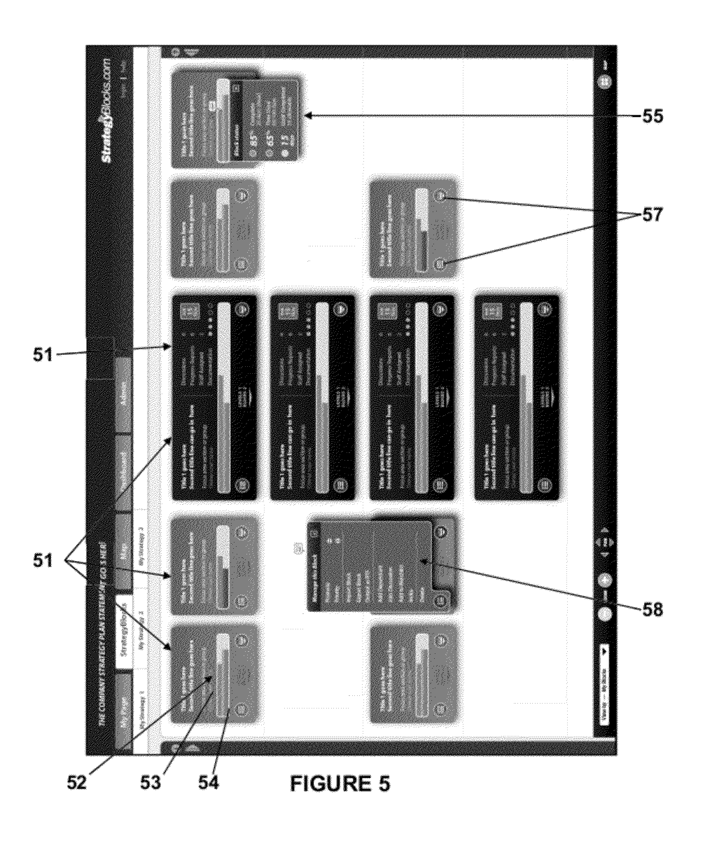

FIG. 5 shows a screenshot of a display which may be viewed by an individual within an entity according to an embodiment of the invention. The display includes a number of blocks 51, only a few of which have been marked to aid clarity. Each block is preferably identified with a title as well as by the group and/or individual responsible therefor. Each block further includes a progress indicator 52 which displays the scheduled status 53 of an initiative adjacent to an actual status 54 so as to provide a readily interpretable view on the status of a task or project. Where progress is ahead of schedule, the status may be represented in a different colour to initiatives that are behind schedule so as to more readily distinguish between the two. More detail may be selectively displayed as shown in box 55.

Additional status indicators 56 may be selectively displayed. For example, an indication of the number of discussions, the number of progress reports, the number of staff assigned and/or details of documentation relating to an initiative may be displayed.

Toolbars and icons, such as icons 57, may be provided to enable users to manage and view information relating to the entity's corporate strategy. Menus 58 may also be provided.

Thus, the invention provides means for calculating and communicating the health of an organisation in terms of its strategic goals, using a number of configurable variables that impact on defined goals, the variables being monitored by searching and tracking related information artefacts. Additional benefits or advantages that may be realised by embodiments of the invention include:
provision of a single, consistent version of all goals, strategies, initiatives and projects which may be stored in a single place, either local to or remote from a particular entity;
the capture and archiving of the structure of past initiatives which may be reused (or not) in other parts of the entity's business or in the future (e.g. if a particular team and approach is highly successful, the invention provides a means for readily identifying the potential suitability of that team/approach in another, similar project);
the user interface of the invention enables individuals to monitor progress, accountability and ownership of activities relating to an initiative, with visibility provided from top to bottom; and
prioritisation of strategic initiatives and the functionality of determining and guiding an individual/team to what is “strategically” the next most important task/use of their time.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to specific components or integers of the invention having known equivalents, then such equivalents are herein incorporated as individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. An organisational tool, comprising:
a reception module for receiving information;
a collation module for collating at least a portion of the information to form information artefacts, wherein the collation module is configured to:
conduct one or more search passes of the information;
determine a linkage between data elements; and
identify linked data elements as said information artefacts, each information artefact having an impact on one or more aspects of the strategic health of an organisation;
a derivation module for deriving a value for one or more of said information artefacts; and
an assessment module for assessing a magnitude or measure of the impact on the strategic health of the organisation based on the derived values.

2. The tool of claim 1, further comprising an extraction module for extracting data relevant to the organisation's strategic health from one or more databases, the information received by the reception module including said data.

3. The tool of claim 1, wherein the assessment module is configured to assess the magnitude of the impact based on a function of one or more of said information artefacts.

4. The tool of claim 1, wherein the assessment module includes weighting means for applying a weighting coefficient to one or more of the information artefacts.

5. The tool of claim 1, wherein the assessment module includes sensitivity means for applying a sensitivity analysis to one or more of the information artefacts.

6. The tool of claim 1, further comprising display module for displaying and/or transmitting at least a portion of one or more of the information artefacts and/or the derived values therefor and/or the magnitude or measure of the impact on the organisation's strategic health.

7. The tool of claim 1, further comprising a linking module for linking one or more of the information artefacts and/or derived values.

8. The tool of claim 1, further comprising an ownership assignment module for assigning ownership to an organisational strategy or part thereof or group of strategies.

9. The tool of claim 8, further comprising a hierarchy assignment module for assigning a hierarchy of strategies and/or a hierarchy of users.

10. The tool of claim 9, wherein the ownership assignment module is configured to assign strategies to users based at least in part on the hierarchy.

11. The tool of claim 1, further comprising a value establishment module for establishing a value to apportion to a strategy or aspects thereof.

12. The tool of claim 11, wherein the value is a financial measure.

13. The tool of claim 1, further comprising an import/export module for importing and/or exporting at least a subset or portion of a strategic plan and/or values derived therefor.

14. An information and/or computing system, comprising:
a reception module for receiving information;
a collation module for collating at least a portion of the information to form information artefacts, wherein the collation module is configured to:
conduct one or more search passes of the information;
determine a linkage between data elements; and
identify linked data elements as said information artefacts, each information artefact having an impact on one or more aspects of the strategic health of an organisation;
a derivation module for deriving a value for one or more of said information artefacts;
an assessment module for assessing a magnitude or measure of the impact on the strategic health of the organisation based on the derived values;
a user terminal; and
a wired and/or wireless communications interface for exchanging data between the organisational tool and the user terminal.

15. The system of claim 14, comprising a plurality of said user terminals, wherein the communications interface is configured to exchange data between the organisational tool and each user terminal.

16. The system of claim 14, further comprising a user access module adapted to assign different access privileges to different users to vary the extent of access to read and/or view and/or write information in or to the system.

17. A computer readable storage medium that includes instructions configured to perform a method of determining or monitoring the strategic health of an organisation, comprising:
receiving information;
collating the information to form information artefacts, each information artefact having an impact on one or more aspects of the strategic health of an organisation, wherein collating comprises:
conducting one or more search passes of the information;
determining a linkage between data elements; and
identifying linked data elements as said information artefacts;
deriving a value for one or more of said information artefacts; and
assessing a magnitude of the impact on the strategic health of the organisation based on the derived values.

18. The method of claim 17, wherein at least one of the steps of receiving, collating, deriving and assessing is repeated to update the derived values.

19-24. (canceled)
